(19) United States
(12) Patent Application Publication
(10) Pub. No.: US 2020/0365025 A1
(43) Pub. Date: Nov. 19, 2020

(54) CONTROL DEVICE, PARKING LOT SYSTEM, CONTROL METHOD, AND STORAGE MEDIUM

(71) Applicant: HONDA MOTOR CO., LTD., Tokyo (JP)

(72) Inventors: Junpei Noguchi, Wako-shi (JP); Ryoma Taguchi, Tokyo (JP); Yuta Takada, Tokyo (JP); Chie Sugihara, Tokyo (JP)

(21) Appl. No.: 16/872,406

(22) Filed: May 12, 2020

(30) Foreign Application Priority Data
May 14, 2019 (JP) 2019-091318

(51) Int. Cl. G08G 1/14; B60W 30/16; B60W 30/14; E04H 6/30

(52) U.S. Cl. CPC G08G 1/14; E04H 6/30; B60W 30/143; B60W 30/16

(57) ABSTRACT

A control device includes a transport mechanism that can transport one or more vehicles placed on the transport mechanism in an area where at least boarding or alighting is performed and a transport mechanism controller that controls an operation of the transport mechanism, wherein the transport mechanism controller controls the transport mechanism to transport a vehicle placed on the transport mechanism to a parking position.

### CROSS-REFERENCE TO RELATED APPLICATION

Priority is claimed on Japanese Patent Application No. 2019-091318, filed May 14, 2019, the content of which is incorporated herein by reference.

### BACKGROUND

### Field of the Invention

The present invention relates to a control device, a parking lot system, a control method, and a storage medium.

### Description of Related Art

Research on automatic control of vehicles has advanced in recent years. In this regard, a technique of automatically controlling a vehicle to park it in a valet parking lot is known (Japanese Unexamined Patent Application, First Publication No. 2018-145655).

### SUMMARY

Here, a transport mechanism capable of transporting a vehicle is provided in a valet parking lot and a control device controls the operation of the transport mechanism to park the vehicle in the valet parking lot. Thus, it is possible to automatically control a vehicle to park it in the valet parking lot even when the vehicle has no function of automatically controlling the vehicle. However, the transport mechanism cannot be controlled in the related art.

The present invention has been made in view of such circumstances and it is an object of the present invention to provide a control device, a parking lot system, a control method, and a storage medium that can automatically park a vehicle.

The control device, the parking lot system, the control method, and the storage medium according to the present invention employ the following configurations.

(1) A control device according to an aspect of the present invention includes a transport mechanism configured to transport one or more vehicles placed on the transport mechanism in an area where at least boarding or alighting is performed, and a transport mechanism controller configured to control an operation of the transport mechanism, wherein the transport mechanism controller is configured to control the transport mechanism to transport a vehicle placed on the transport mechanism to a parking position.

(2) The control device according to the above aspect (1) further includes a recognizer configured to recognize a surrounding environment of the transport mechanism, wherein the transport mechanism is provided such that at least a part of the transport mechanism faces a boarding/alighting area where passengers board or alight from vehicles, and the transport mechanism controller is configured to stop the operation of the transport mechanism when a recognition result of the recognizer indicates that a passenger is boarding or alighting from a vehicle in the boarding/alighting area.

(3) In the control device according to the above aspect (2), the transport mechanism includes a belt conveyor.

(4) In the control device according to the above aspect (3), the transport mechanism controller is configured to cause the belt conveyor to operate to transport a vehicle placed on the belt conveyor to a parking area when the recognizer has recognized that no passenger is boarding or alighting from the vehicle placed on the belt conveyor in the boarding/alighting area.

(5) The control device according to the above aspect (3) further includes an instructor configured to, when an inter-vehicle distance between a plurality of vehicles placed on the belt conveyor recognized by the recognizer is equal to or greater than a predetermined threshold, instruct a vehicle, which is relatively behind in a travel direction among the plurality of vehicles, to reduce the inter-vehicle distance.

(6) In the control device according to the above aspect (3), the transport mechanism controller is configured to cause the belt conveyor to operate at a speed at which a passenger is able to board or alight from a vehicle on the belt conveyor when the recognizer has recognized that a time it takes for the passenger to board or alight from the vehicle in the boarding/alighting area is equal to or longer than a predetermined time.

(7) In the control device according to the above aspect (3), the belt conveyor includes a plurality of sub-belt conveyors provided in parallel, and a sub-belt conveyor which a vehicle is to use among the plurality of sub-belt conveyors is predetermined on the basis of the number of passengers in the vehicle.

(8) In the control device according to the above aspect (3), the belt conveyor includes a plurality of sub-belt conveyors provided in parallel, and the transport mechanism controller is configured to cause the plurality of sub-belt conveyors to operate at different speeds.

(9) In the control device according to the above aspect (3), the belt conveyor includes a plurality of sub-belt conveyors provided in parallel, and a sub-belt conveyor which a vehicle scheduled to use a parking area is to use among the plurality of sub-belt conveyors and a sub-belt conveyor which a vehicle not scheduled to use the parking area is to use are predetermined.

(10) A parking lot system according to another aspect of the present invention includes the control device according to the above aspect (1) and a vehicle control system, wherein the vehicle control system includes a recognizer configured to recognize a surrounding environment of a vehicle, and a driving controller configured to perform at least one of speed control and steering control of the vehicle on the basis of a recognition result of the recognizer, and the driving controller is configured to stop the speed control and steering control of the vehicle when the recognizer has recognized that the vehicle is placed on a transport mechanism configured to transport one or more vehicles placed on the transport mechanism in an area where at least boarding or alighting is performed.

(11) In the parking lot system according to the above aspect (10), the driving controller is configured to cause the vehicle to travel to reduce an inter-vehicle distance between the vehicle and another vehicle placed on the transport mechanism when the inter-vehicle distance between the vehicle and the other vehicle recognized by the recognizer is equal to or greater than a predetermined threshold and the vehicle is present behind the other vehicle.

(12) In the parking lot system according to the above aspect (11), the transport mechanism is provided such that at least a part of the transport mechanism faces a boarding/alighting area where passengers board or alight from vehicles, and the driving controller is configured to cause the vehicle to advance at a speed at which the passenger is able to board or alight from the vehicle when the recognizer has recognized that a time it takes for the passenger to board or alight from the vehicle in the boarding/alighting area is equal to or longer than a predetermined time.

(13) A control method according to another aspect of the present invention includes a computer controlling an operation of a transport mechanism configured to transport one or more vehicles placed on the transport mechanism in an area where at least boarding or alighting is performed, and transporting a vehicle placed on the transport mechanism to a parking position.

(14) A storage medium according to another aspect of the present invention is a non-transitory computer-readable storage medium storing a program that causes a computer to control an operation of a transport mechanism configured to transport one or more vehicles placed on the transport mechanism in an area where at least boarding or alighting is performed, and transport a vehicle placed on the transport mechanism to a parking position.

According to the above aspects (1) to (14), the vehicle can be automatically parked.

According to the above aspect (2), the passenger can safely board or alight from the vehicle.

According to the above aspects (4) to (9), the vehicle can be efficiently parked.

According to the aspects (10) to (12), it is possible to prevent the function of causing the vehicle to automatically travel from hindering the parking.

### BRIEF DESCRIPTION OF THE DRAWINGS

FIG. 1 is a diagram showing an example of a configuration of a parking lot system using a control device according to a first embodiment.

FIG. 2 is a diagram showing a part of a configuration of a belt conveyor.

FIG. 3 is a diagram showing an example of a configuration of a parking lot management device.

FIG. 4 is a diagram showing an example of a configuration of the control device according to the first embodiment.

FIG. 5 is a diagram showing a top view of the belt conveyor in a stop area.

FIG. 6 is a diagram showing an example of the content of lane information.

FIG. 7 is a diagram showing an example of a situation in which a passenger alights from a vehicle in a stop area.

FIG. 8 shows an example of a situation in which an image indicating an instruction for a driver of a vehicle is displayed on a display.

FIG. 9 is a diagram showing an example of the image displayed on the display in the situation shown in FIG. 8.

FIG. 10 is a flowchart showing an example of a series of operations of the control device of the first embodiment.

FIG. 11 is a flowchart showing an example of processing of a display controller.

FIG. 12 is a configuration diagram of a vehicle control system SY according to a second embodiment.

FIG. 13 is a functional configuration diagram of a first controller and a second controller.

FIG. 14 is a diagram showing an example of a hardware configuration of an automated driving control device according to an embodiment.

### DESCRIPTION OF EMBODIMENTS

### First Embodiment

Hereinafter, a control device, a parking lot system, a control method, and a storage medium according to a first embodiment of the present invention will be described with reference to the drawings.

### [Configuration of Valet Parking Lot]

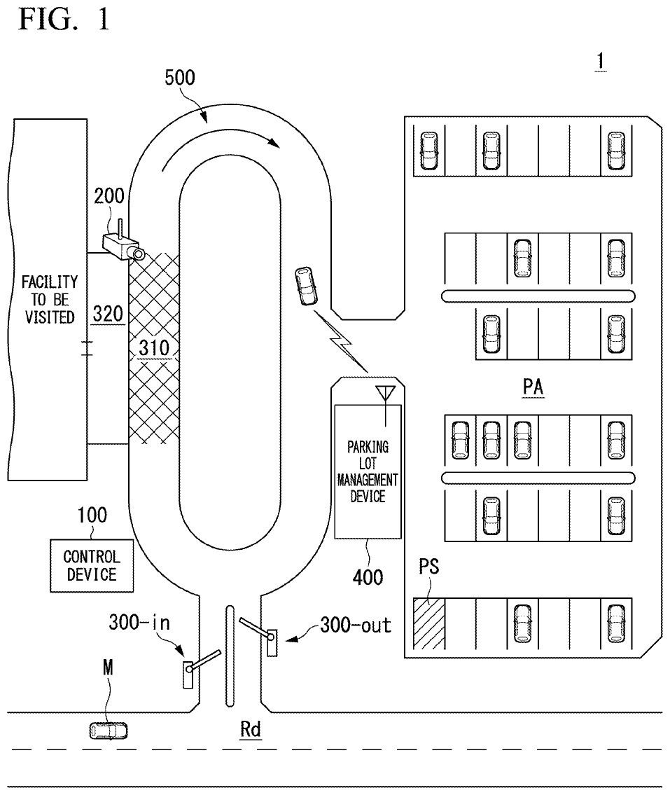

FIG. 1 is a diagram showing an example of a configuration of a parking lot system 1 using a control device 100 according to the first embodiment. The parking lot system 1 includes, for example, the control device 100, an imaging device 200, gates 300, a parking lot management device 400, and a belt conveyor 500. The parking lot system 1 is a system which stores a vehicle, in which there is a user who is about to use a facility to be visited, in a parking lot PA of the facility to be visited or retrieves the vehicle, in which there is the user who has used the facility to be visited, from the parking lot PA. Gates 300-in and 300-out are provided on a route from a road Rd to the facility to be visited. A traveling path on which the vehicle is to travel after the gates 300 is made of the belt conveyor 500.

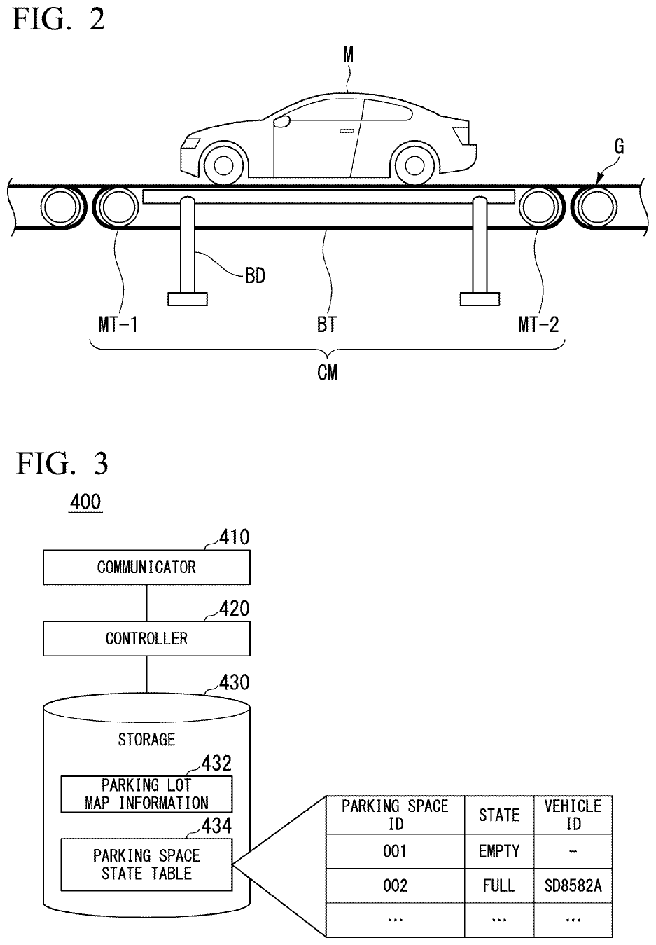

FIG. 2 is a diagram showing a part of a configuration of the belt conveyor 500. The belt conveyor 500 is a device including, for example, one or more components CM, each of which includes one or more drive units MT (drive units MT-1 and MT-2 shown in the drawing), a belt BT, and a base BD. Each drive unit MT is realized, for example, by a motor. The belt BT is formed in a wide ring shape and the drive unit MT-1 and the drive unit MT-2 are provided respectively on one inner side and the other inner side of the belt. The base BD has a top surface on which an upper portion of the belt BT is located, and supports a vehicle (hereinafter a vehicle M) placed on the belt BT. One or more vehicles M are placed on top surfaces of belts BT of the belt conveyor 500 and the drive units MT are driven under control of the control device 100 to rotate the belts BT such that the vehicles M placed on the tops of the belts BT are transported in a direction (for example, forward or backward) according to the rotation of the belts BT. The components CM are installed close to each other and thus the belt conveyor 500 transports vehicles M to parking spaces PS in the parking lot PA over the belts BT of one or more components CM. The belt conveyor 500 is an example of the “transport mechanism.”

Returning to FIG. 1, when a vehicle M that has passed through the gate 300-in has been detected by the gate 300-in and placed on the belt conveyor 500, the control device 100 controls the belt conveyor 500 to transport the vehicle M to the stop area 310. The stop area 310 faces a boarding/alighting area 320 connected to the facility to be visited. An eave for blocking rain and snow may be provided in the boarding/alighting area 320. For example, an imaging device 200 (not shown) capable of imaging the entirety of the stop area 310 is installed in the stop area 310 and the control device 100 acquires an image showing the stop area 310 captured by the imaging device 200.

After a passenger alights from a vehicle M in the stop area 310, the control device 100 controls the belt conveyor 500 to start transport for storage of the vehicle M into a parking space PS in the parking lot PA. A start trigger of transport for storage is generated, for example, on the basis of a predetermined schedule or an instruction that the passenger has issued using his or her terminal device. When the transport for storage has started, the control device 100 controls a communication device 120 which will be described later to transmit a parking request to the parking lot management device 400. The control device 100 transports the vehicle M from the stop area 310 to the parking lot PA and then to the parking space PS and parks it in the parking space PS on the basis of information acquired from the parking lot management device 400. The parking lot PA is, for example, an example of the “parking area.”

FIG. 3 is a diagram showing an example of a configuration of the parking lot management device 400. The parking lot management device 400 includes, for example, a communicator 410, a controller 420, and a storage 430. The storage 430 stores information such as parking lot map information 432 and a parking space state table 434.

The communicator 410 communicates with the control device 100. The controller 420 determines a parking space PS for parking a vehicle M on the basis of information such as a parking request that has been received from the control device 100 through the communicator 410 and information stored in the storage 430. The parking lot map information 432 is information geometrically representing the structure of the parking lot PA. The parking lot map information 432 includes coordinates of each parking space PS. The parking space state table 434 includes, for example, a table in which each parking space ID which is identification information of a parking space PS is associated with a state indicating whether the parking space is empty or full (parked in) and a vehicle ID which is identification information of a vehicle parked in the parking space if it is full.

When the communicator 410 has received a parking request from the control device 100, the controller 420 refers to the parking space state table 434 to extract a parking space PS which is empty, acquires the position of the extracted parking space PS from the parking lot map information 432, and transmits a suitable route to the acquired position of the parking space PS to the control device 100 using the communicator 410. Based on the positional relationships of a plurality of vehicles, the controller 420 transmits, to the control device 100, an instruction for a specific vehicle to stop, slow down or the like as necessary such that vehicles do not proceed to the same position at the same time.

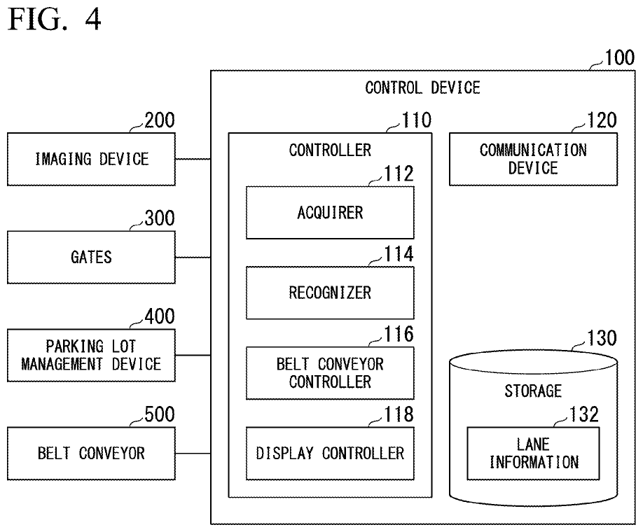

FIG. 4 is a diagram showing an example of a configuration of the control device 100 according to the first embodiment. The control device 100 is connected, for example, to the imaging device 200, the gates 300, the parking lot management device 400, and the belt conveyor 500 via a wired or wireless network. The control device 100 includes a controller 110, a communication device 120, and a storage 130. The controller 110 realizes the respective functions of an acquirer 112, a recognizer 114, a belt conveyor controller 116, and a display controller 118, for example, by a processor such as a central processing unit (CPU) executing a program (software) stored in the storage 130. Some or all of these components may be realized by hardware (including circuitry) such as large scale integration (LSI), an application specific integrated circuit (ASIC), a field-programmable gate array (FPGA), or a graphics processing unit (GPU) or may be realized by hardware and software in cooperation.

The communication device 120 communicates, for example, with the gates 300 and the parking lot management device 400 via a network. The network includes, for example, all or a part of the Internet, a cellular network, a Wi-Fi network, a wide area network (WAN), a local area network (LAN), a public line, a telephone line, and a wireless base station.

The storage 130 may be realized by a storage device such as a hard disk drive (HDD) or a flash memory (a storage device having a non-transitory storage medium) or may be realized by a detachable storage medium such as a DVD or a CD-ROM (a non-transitory storage medium) or may be a storage medium to be mounted in a drive device. All or a part of the storage 130 may be an external device that the control device 100 can access, such as a NAS or an external storage server. The storage 130 stores, for example, information such as lane information 132 in addition to programs. Details of the lane information 132 will be described later.

The acquirer 112 acquires a captured image of the stop area 310 from the imaging device 200 via the communication device 120, acquires a result of detection of the presence or absence of a vehicle to be stored from the gates 300, and acquires information indicating a route to a parking space PS for a vehicle M that begins to be transported for storage from the parking lot management device 400.

The recognizer 114 recognizes a state of a vehicle M in the stop area 310 on the basis of the captured image of the stop area 310 acquired by the acquirer 112. For example, the recognizer 114 recognizes the presence or absence of a passenger who is boarding a vehicle M in the stop area 310, the presence or absence of a passenger who is alighting from the vehicle M, the position of the vehicle M, the speed of the vehicle M, the acceleration of the vehicle M, and the number of passengers who are in the vehicle M.

Based on the information indicating the route to the parking space PS acquired by the acquirer 112, the lane information 132, and the recognition result of the recognizer 114, the belt conveyor controller 116 controls the operation of the belt conveyor 500 to transport the vehicle M to the parking lot PA and park it in the parking space PS. The belt conveyor controller 116 is an example of the “transport mechanism controller.”

The display controller 118 displays various types of information on displays installed in the stop area 310 which will be described later. An image displayed by the display controller 118 is, for example, an image indicating an instruction for a driver of a vehicle M. The display controller 118 is an example of the “instructor.”

### [About Lanes LN of Belt Conveyor 500]

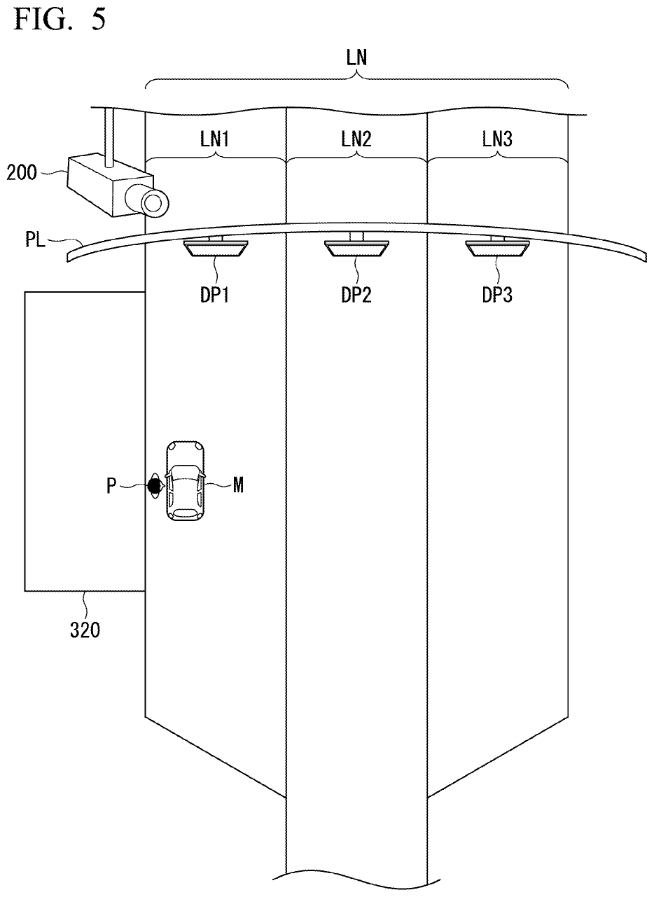

First, details of the belt conveyor 500 in the stop area 310 will be described. FIG. 5 is a diagram showing a top view of the belt conveyor 500 in the stop area 310. The belt conveyor 500 includes, for example, one or more sub-belt conveyors (hereinafter referred to as lanes LN) provided in parallel to each other in the stop area 310. In the example shown in FIG. 5, the belt conveyor 500 includes three lanes, a first lane LN1, a second lane LN2, and a third lane LN3. The belt conveyor 500 may include one lane or may include four or more lanes. The lanes LN are made of different components CM. Therefore, the belt conveyor controller 116 can control the operation of the belt conveyor 500 such that the lanes LN have different speeds. Hereinafter, it is assumed that the belt conveyor controller 116 causes the belt conveyor 500 to operate in any of the lanes LN at a speed at which a passenger can board or alight from a vehicle M placed on the belt conveyor 500 (for example, at about several km/h to about several tens of km/h) while the lanes LN have different speeds (for example, the first lane LN1 has a “low speed,” the second lane LN2 has a “medium speed,” and the third lane LN3 has a “high speed”).

A support portion PL crossing over the lanes LN is installed in the stop area 310 and displays DP (displays DP1 to DP3 shown in FIG. 5), each of which displays an image indicating an instruction for a driver of a vehicle traveling in a corresponding lane LN, are attached to the support portion PL such that the displays are visible to the driver.

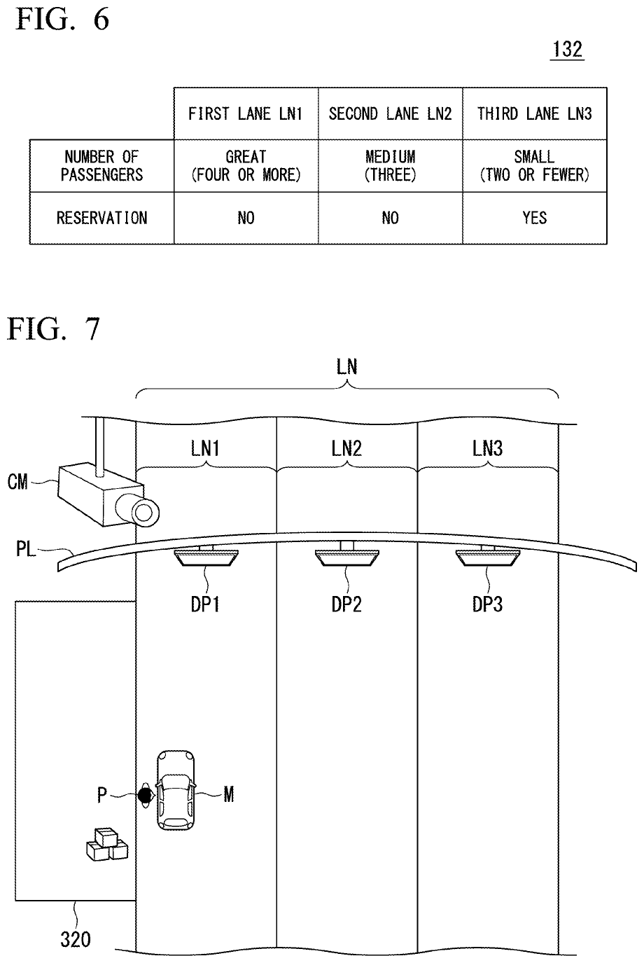

The belt conveyor controller 116 controls the operation of the belt conveyor 500 on the basis of the information indicating the route to the parking space PS acquired by the acquirer 112, the lane information 132, and the recognition result of the recognizer 114 as described above. FIG. 6 is a diagram showing an example of the content of the lane information 132. The lane information 132 is information indicating associations between information regarding the recognition result of the recognizer 114 and the lanes LN.

In the example shown in FIG. 6, the lane information 132 includes information indicating associations between the number of passengers in a vehicle recognized by the recognizer 114 and the lanes LN. The first lane LN1 is closest to the stop area 310 and thus it is easy to board or alight in the first lane LN1. Therefore, the first lane LN1 is predetermined as a lane to be used by a vehicle having a greater number of passengers (for example, four or more) than that of the other lanes LN. On the other hand, the third lane LN3 is farthest from the stop area 310 and thus it is difficult to move from the facility to be visited to the third lane LN3 or from the third lane LN3 to the facility to be visited. Therefore, the third lane LN3 is predetermined as a lane to be used by a vehicle having a smaller number of passengers (for example, two or fewer) than that of the other lanes LN. The second lane LN2 is predetermined as a lane to be used by a vehicle having a number of passengers (for example, three) smaller than that of the first lane LN1 and greater than that of the third lane LN3. The belt conveyor controller 116 determines a lane LN in which the vehicle M is to be placed on the basis of the number of passengers in the vehicle M indicated by the recognition result of the recognizer 114 and controls the operation of the belt conveyor 500 to move and transport the vehicle M. This allows the belt conveyor controller 116 to transport the vehicle M to the parking lot PA and park it in the parking space PS without crowding the stop area 310.

In the example shown in FIG. 6, the lane information 132 includes associations between whether or not a vehicle M recognized by the recognizer 114 has a reservation for use of the parking lot PA and the lanes LN. In the third lane LN3, a smaller number of people board or alight from vehicles and vehicles can more smoothly move to the parking lot PA than in the first lane LN1. Therefore, the third lane LN3 is predetermined as a lane to be used by a vehicle having a reservation for the parking lot PA. On the other hand, the first lane LN1 and the second lane LN2 are predetermined as lanes to be used by vehicles having no reservation for the parking lot PA. The belt conveyor controller 116 acquires information that enables identification of the vehicle M (for example, the number of a vehicle registration number tag) from the recognition result of the recognizer 114 and provides the acquired information to the parking lot management device 400. The parking lot management device 400 provides the control device 100, for example, with information indicating whether or not a vehicle related to the acquired information has a reservation for the parking lot PA. The belt conveyor controller 116 determines a lane LN in which the vehicle M is to be placed on the basis of the acquired information indicating whether or not the vehicle M has a reservation and controls the operation of the belt conveyor 500 to move and transport the vehicle M. Thereby, even if the parking lot PA is congested with vehicles having no reservation, the belt conveyor controller 116 can preferentially transport a vehicle having a reservation to the parking lot PA and park it in a parking space PS.

### [When Passenger is Boarding or Alighting in Stop Area 310]

For example, when a recognition result of the recognizer 114 indicates that a passenger is boarding or alighting from a vehicle M in the stop area 310, the belt conveyor controller 116 stops the operation of a sub-belt conveyor of the belt conveyor 500 related to the lane LN of the vehicle M. In the example shown in FIG. 5, the belt conveyor controller 116 controls the belt conveyor 500 to stop the operation of the first lane LN1 because a passenger P is about to board a vehicle M in the first lane LN1. Thereby, the belt conveyor controller 116 allows the passenger P to safely board or alight from the vehicle.

### [When No Passenger is Boarding or Alighting in Stop Area 310]

For example, when a recognition result of the recognizer 114 indicates that no passenger is boarding or alighting from a vehicle M in the stop area 310, the belt conveyor controller 116 does not stop the operation of a sub-belt conveyor of the belt conveyor 500 related to the lane LN of the vehicle M. Thus, the belt conveyor controller 116 transports a vehicle M which has no need for boarding or alighting in the stop area 310 without stopping the belt conveyor 500, such that the vehicle M can be parked efficiently.

[When Time it Takes to Board or Alight in Stop Area 310 is Equal to or Longer than Predetermined Time]

FIG. 7 is a diagram showing an example of a situation in which a passenger P alights from a vehicle M in the stop area 310. For example, when a recognition result of the recognizer 114 indicates that the time it takes for a passenger to board or alight from a vehicle M in the stop area 310 is equal to or longer than a predetermined time Tht, the belt conveyor controller 116 performs control such that the speed is low. The low speed is, for example, a speed at which a passenger P can board or alight from the vehicle M.

In the example shown in FIG. 7, the passenger P is about to load luggage into the vehicle M and thus the time it takes for the passenger P to board or alight from the vehicle M is longer than usual and is equal to or longer than the predetermined time Tht. The belt conveyor controller 116 stops the operation of the belt conveyor 500 in the lane LN of the vehicle M when a passenger P is boarding or alighting from a vehicle M as described above. However, the belt conveyor controller 116 controls the belt conveyor 500 such that the first lane LN1 has a low speed from the time at which it is recognized that the time it takes for the passenger P to board or alight is equal to or longer than the predetermined time Tht. Thereby, the belt conveyor controller 116 can allow the passenger P to board or alight from the vehicle M and prevent congestion of vehicles following the vehicle M while keeping the vehicle M from passing through the stop area 310.

### [Instruction to Reduce Inter-Vehicle Distance]

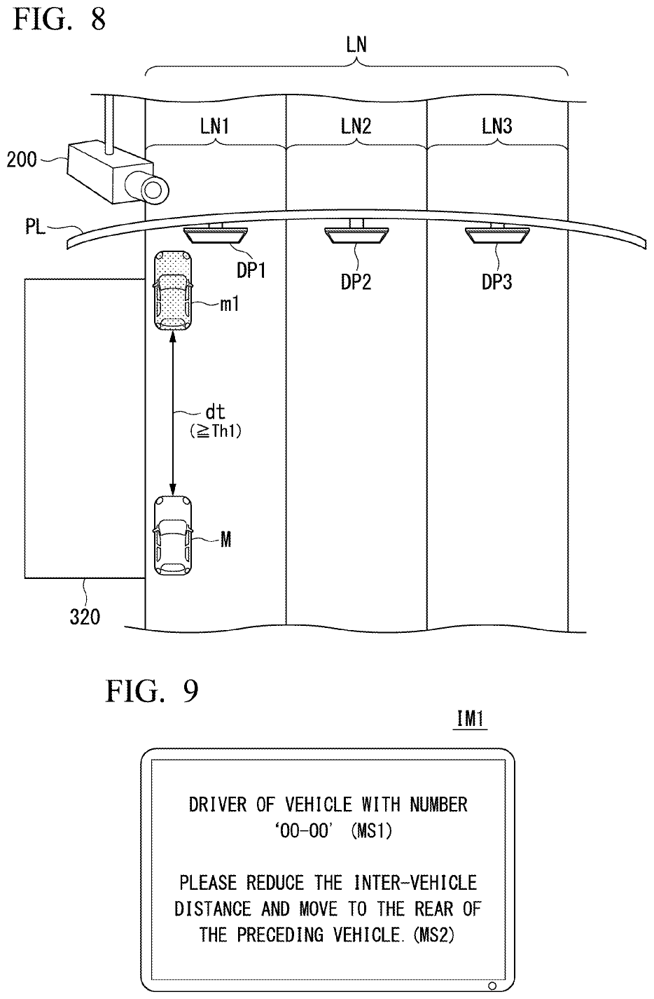

FIG. 8 shows an example of a situation in which an image indicating an instruction for a driver of a vehicle M is displayed on a display DP. For example, when a recognition result of the recognizer 114 indicates that the inter-vehicle distance between a plurality of vehicles in a lane LN among a plurality of vehicles placed on the belt conveyor 500 is equal to or greater than a predetermined threshold Th1, the display controller 118 displays an image instructing a vehicle, which is behind in the travel direction of vehicles (or the lane LN) among the plurality of vehicles, to reduce the inter-vehicle distance. In FIG. 8, a vehicle M and another vehicle m1 ahead of the vehicle M are present in the first lane LN1 and an inter-vehicle distance dt between the vehicle M and the other vehicle m1 is equal to or greater than the predetermined threshold Th1. When the recognition result of the recognizer 114 indicates that the inter-vehicle distance dt is equal to or greater than the predetermined threshold Th1, the display controller 118 causes the display DP to display an image instructing one of the vehicle M and the other vehicle m1 which is behind in the travel direction (the vehicle M in this case) to reduce the inter-vehicle distance.

FIG. 9 is a diagram showing an example of an image IM1 displayed on the display DP1 in the situation shown in FIG. 8. The image IM1 includes, for example, a message MS1 including information (for example, a vehicle registration number tag) which enables identification of a vehicle to be instructed (the vehicle M in this case) and a message MS2 indicating an instruction for the vehicle M to be instructed. The message MS1 is, for example, “Driver of vehicle with number ‘◯◯-◯◯’” and the message MS2 is, for example, “Please reduce the inter-vehicle distance and move to the rear of the preceding vehicle.” Upon receiving the instruction, the driver of the vehicle M causes the vehicle M to travel on the belt conveyor 500 such that the vehicle M approaches the preceding vehicle and the inter-vehicle distance is reduced. Thereby, the display controller 118 allows the vehicle to be efficiently parked.

The above description refers to the case where the display controller 118 causes the display DP to display an image IM for an instruction to reduce the inter-vehicle distance, but the present invention is not limited to this. The display controller 118 may issue, for example, an instruction other than to reduce the inter-vehicle distance to the driver or passenger of the vehicle M. For example, the display controller 118 may issue an instruction to prevent movement of the vehicle M by causing the display DP to display an image indicating the instruction to prevent movement of the vehicle M (for example, “There is someone boarding or alighting. Please do not move.”) at the time when it is undesirable to move the vehicle M such as when a passenger is boarding or alighting from a vehicle in an adjacent lane LN.

The above description also refers to the case where the display controller 118 displays an image IM on the display DP to issue various instructions to the driver and the passenger of the vehicle M. However, the present invention is not limited to this. The control device 100 may issue various instructions to the driver of the vehicle M, for example, by sound or blinking of an indicator light in addition to the image IM. In this case, the support portion PL is provided, for example, with human machine interfaces (HMIs) such as an indicator light and a speaker in addition to the displays DP and the control device 100 controls these HMIs to issue various instructions to the driver or passenger of the vehicle M.

### [Operation Flow]

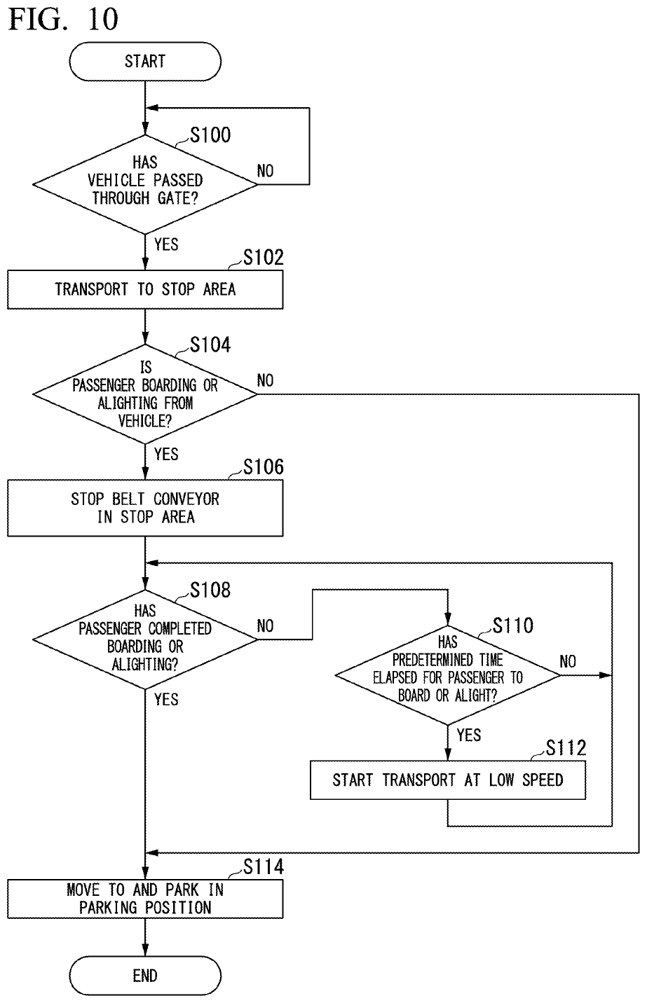

FIG. 10 is a flowchart showing an example of a series of operations of the control device 100 of the first embodiment. In the flowchart of FIG. 10, for example, processing is performed for each vehicle M that has passed through the gate 300-in. First, the belt conveyor controller 116 determines whether or not a vehicle M that has passed through the gate 300-in has been detected by the gate 300-in and placed on the belt conveyor 500 (step S100). The belt conveyor controller 116 waits until a vehicle M that has passed through the gate 300-in is detected and determined to be placed on the belt conveyor 500. Upon determining that a vehicle M that has passed through the gate 300-in is detected and determined to be placed on the belt conveyor 500, the belt conveyor controller 116 controls the belt conveyor 500 to transport the vehicle M to the stop area 310 (step S102).

The belt conveyor controller 116 determines whether or not a recognition result of the recognizer 114 indicates that a passenger is in the vehicle M (step S104). Upon determining that the recognition result of the recognizer 114 indicates that no passenger is in the vehicle M or indicates that no passenger is boarding or alighting from the vehicle M in the stop area 310, the belt conveyor controller 116 advances the process to step S114. Upon determining that the recognition result of the recognizer 114 indicates that a passenger is boarding or alighting from the vehicle M in the stop area 310, the belt conveyor controller 116 stops a sub-belt conveyor of the belt conveyor 500 related to a lane LN in which the vehicle is being transported (step S106). The belt conveyor controller 116 determines whether or not the recognition result of the recognizer 114 indicates that a passenger P has completed boarding or alighting from the vehicle M in the stop area 310 (step S108). Upon determining that a passenger P has completed boarding or alighting from the vehicle M, the belt conveyor controller 116 advances the process to step S114.

Based on the recognition result of the recognizer 114, the belt conveyor controller 116 determines whether or not the time it takes for the passenger P to board or alight from the vehicle M in the stop area 310 is equal to or longer than the predetermined time Tht (step S110). If the time it takes for the passenger P to board or alight from the vehicle M is equal to or longer than the predetermined time Tht, the belt conveyor controller 116 causes the sub-belt conveyor of the belt conveyor 500 related to the lane LN of the vehicle M to operate at a low speed and start transporting the vehicle M to the parking lot PA (step S112). The belt conveyor controller 116 repeats the processing of steps S108 to S112 until the passenger P completes boarding or alighting from the vehicle M. Upon determining that the passenger P has completed boarding or alighting from the vehicle M, that no passenger is in the vehicle M, or that no passenger is boarding or alighting from the vehicle M in the stop area 310, the belt conveyor controller 116 causes the sub-belt conveyor of the belt conveyor 500 related to the lane LN of the vehicle M to operate to transport the vehicle M to the parking lot PA and park it in the parking space PS (step S114).

For example, upon determining that no passenger is in the vehicle M, the belt conveyor controller 116 may transport the vehicle M to the parking lot PA without stopping the belt conveyor 500 or lowering the speed thereof. The belt conveyor controller 116 may lower the speed of the belt conveyor 500 in a determination period during which it determines whether or not the passenger P is about to board or alight from the vehicle M in the stop area 310 and, upon determining that no passenger P is boarding or alighting from the vehicle M in the determination period, increase the speed of the belt conveyor 500 (for example, to a normal speed) such that the vehicle M is transported to the parking lot PA.

The case where the processing of steps S100 to S108 and step S114 and the processing of steps S110 to S112 are realized in the same flowchart has been described above. However, the present invention is not limited to this and the processing of steps S100 to S108 and step S114 and the processing of steps S110 to S112 may be performed in different flowcharts at the respective timings.

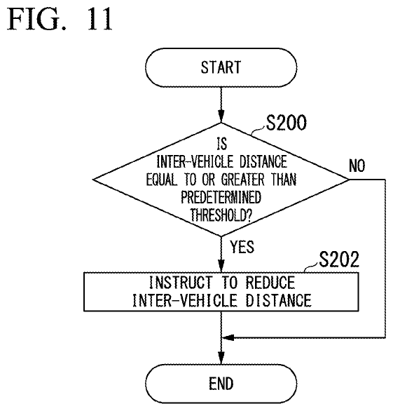

FIG. 11 is a flowchart showing an example of processing of the display controller 118. The display controller 118 determines whether or not a recognition result of the recognizer 114 indicates that the inter-vehicle distance between a plurality of vehicles in a lane LN among a plurality of vehicles placed on the belt conveyor 500 is equal to or greater than a predetermined threshold Th1 (step S200). Upon determining that the inter-vehicle distance between the plurality of vehicles is equal to or greater than the predetermined threshold Th1, the display controller 118 causes the display DP to display an image IM instructing one of the plurality of vehicles, which is behind in the travel direction of vehicles (or the lane LN), to reduce the inter-vehicle distance, thereby instructing the vehicle behind to reduce the inter-vehicle distance (step S202).

### Summary of First Embodiment

The control device 100 of the present embodiment can automatically park the vehicle M in the parking space PS by controlling the belt conveyor 500 to transport the vehicle M as described above.

In addition, the control device 100 of the present embodiment stops the operation of the belt conveyor 500 until the passenger P completes boarding or alighting from the vehicle M, such that the passenger P can safely board or alight from the vehicle.

Further, the control device 100 of the present embodiment causes the belt conveyor 500 to operate in the stop area 310, for example, when there is no passenger P in the vehicle M, when no passenger P boards or alights from a vehicle M in the stop area 310, or when the time it takes for a passenger P to board or alight from a vehicle M is equal to or longer than the predetermined time Tht, such that the vehicle M can be efficiently parked in the parking space PS.

### [Other Examples of Transport Mechanism]

The above description refers to the case where the belt conveyor 500 transports the vehicle M to the parking lot PA to park it. However, the present invention is not limited to this. The parking lot system 1 may include, for example, a self-propelled undercarriage capable of transporting the vehicle M, instead of the belt conveyor 500. In this case, the control device 100 includes an undercarriage controller instead of the belt conveyor controller 116. The undercarriage controller may control start, stop, or speed change of the operation of the undercarriage on the basis of a recognition result of the recognizer 114 in the same way as the belt conveyor controller 116 controls the start, stop, or speed change of the operation of the belt conveyor 500. In this case, it is assumed that each lane LN is predetermined in a range of a traveling path on which the undercarriage is to travel after the gates 300.

### Second Embodiment

Hereinafter, a parking lot system 2 according to a second embodiment will be described with reference to the drawings. The second embodiment will be described with reference to the case where a vehicle M parked in a parking lot PA is an automated driving vehicle. The same components as those in the embodiment described above are given the same reference signs and descriptions thereof will be omitted.

### [Overall Configuration]

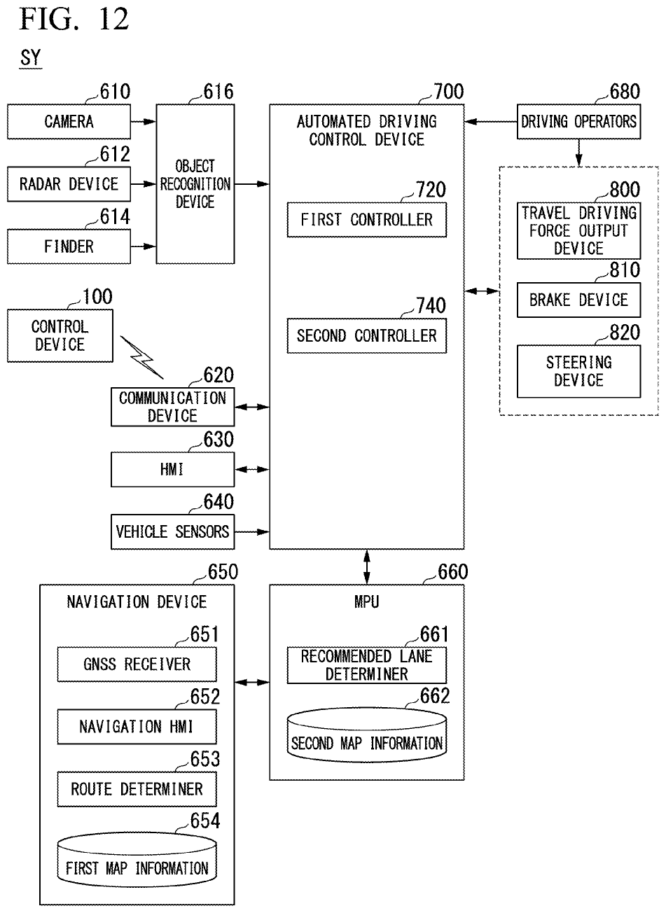

A parking lot system 2 according to the second embodiment includes, for example, a control device 100, an imaging device 200, gates 300, a parking lot management device 400, a belt conveyor 500, and a vehicle control system SY. FIG. 12 is a configuration diagram of the vehicle control system SY according to the second embodiment. A vehicle in which the vehicle control system SY is mounted is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a generator connected to the internal combustion engine or using discharge power of a secondary battery or a fuel cell.

The vehicle control system SY includes, for example, a camera 610, a radar device 612, a finder 614, an object recognition device 616, a communication device 620, an HMI 630, vehicle sensors 640, a navigation device 650, a map positioning unit (MPU) 660, driving operators 680, an automated driving control device 700, a travel driving force output device 800, a brake device 810, and a steering device 820. These devices or apparatuses are connected to each other by a multiplex communication line or a serial communication line such as a controller area network (CAN) communication line, a wireless communication network, or the like. The components shown in FIG. 1 are merely an example and some of the components may be omitted or other components may be added.

The camera 610 is, for example, a digital camera using a solid-state imaging device such as a charge coupled device (CCD) or a complementary metal oxide semiconductor (CMOS). The camera 610 is attached to a vehicle in which the vehicle control system SY is mounted (hereinafter referred to as a vehicle M) at an arbitrary location. For imaging the area in front of the vehicle M, the camera 610 is attached to an upper portion of a front windshield, a rear surface of a rearview mirror, or the like. For example, the camera 610 repeats imaging of the surroundings of the vehicle M at regular intervals. The camera 610 may also be a stereo camera.

The radar device 612 radiates radio waves such as millimeter waves around the vehicle M and detects radio waves reflected by an object (reflected waves) to detect at least the position (distance and orientation) of the object. The radar device 612 is attached to the vehicle M at an arbitrary location. The radar device 612 may detect the position and velocity of an object using a frequency modulated continuous wave (FM-CW) method.

The finder 614 is a light detection and ranging (LIDAR) finder. The finder 614 illuminates the surroundings of the vehicle M with light and measures scattered light. The finder 614 detects the distance to a target on the basis of a period of time from when light is emitted to when light is received. The light radiated is, for example, pulsed laser light. The finder 614 is attached to the vehicle M at an arbitrary location.

The object recognition device 616 performs a sensor fusion process on results of detection by some or all of the camera 610, the radar device 612, and the finder 614 to recognize the position, type, speed, or the like of the object. The object recognition device 616 outputs the recognition result to the automated driving control device 700. The object recognition device 616 may output detection results of the camera 610, the radar device 612, and the finder 614 to the automated driving control device 700 as they are. The object recognition device 616 may be omitted from the vehicle control system SY.

For example, the communication device 620 communicates with, for example, other vehicles present near the vehicle M, a parking lot management device 400, various server devices, or a terminal device such as a smartphone or a tablet owned by a passenger using a cellular network, a Wi-Fi network, Bluetooth (registered trademark), dedicated short range communication (DSRC), or the like.

The HMI 630 presents various types of information to a passenger of the vehicle M and receives an input operation from the passenger. The HMI 630 includes various display devices, a speaker, a buzzer, a touch panel, switches, keys, and the like.

The vehicle sensors 640 include a vehicle speed sensor that detects the speed of the vehicle M, an acceleration sensor that detects the acceleration thereof, a yaw rate sensor that detects an angular speed thereof about the vertical axis, an orientation sensor that detects the orientation of the vehicle M, or the like.

The navigation device 650 includes, for example, a global navigation satellite system (GNSS) receiver 651, a navigation HMI 652, and a route determiner 653. The navigation device 650 holds first map information 654 in a storage device such as a hard disk drive (HDD) or a flash memory. The GNSS receiver 651 identifies the position of the vehicle M on the basis of signals received from GNSS satellites. The position of the vehicle M may also be identified or supplemented by an inertial navigation system (INS) using the output of the vehicle sensors 640. The navigation HMI 652 includes a display device, a speaker, a touch panel, a key, or the like. The navigation HMI 652 may be partly or wholly shared with the HMI 630 described above. For example, the route determiner 653 determines a route from the position of the vehicle M identified by the GNSS receiver 651 (or an arbitrary input position) to a destination input by the passenger using the navigation HMI 652 (hereinafter referred to as an on-map route) by referring to the first map information 654. The first map information 654 is, for example, information representing shapes of roads by links indicating roads and nodes connected by the links. The first map information 654 may include curvatures of roads, point of interest (POI) information, or the like. The navigation device 650 may be realized, for example, by a function of the terminal device. The on-map route is output to the MPU 660. The navigation device 650 may also perform route guidance using the navigation HMI 652 on the basis of the on-map route. The navigation device 650 may also transmit the current position and the destination to a navigation server via the communication device 620 and acquire a route equivalent to the on-map route from the navigation server.

The MPU 660 includes, for example, a recommended lane determiner 661 and holds second map information 662 in a storage device such as an HDD or a flash memory. The recommended lane determiner 661 divides the on-map route provided from the navigation device 650 into a plurality of blocks (for example, into blocks each 100 meters long in the direction in which the vehicle travels) and determines a recommended lane for each block by referring to the second map information 662. The recommended lane determiner 661 determines the number of the lane from the left in which to travel. When there is a branch point on the on-map route, the recommended lane determiner 661 determines a recommended lane such that the vehicle M can travel on a reasonable route for proceeding to the branch destination.

The second map information 662 is map information with higher accuracy than the first map information 654. The second map information 662 includes, for example, information of the centers of lanes or information of the boundaries of lanes. The second map information 662 may also include road information, traffic regulation information, address information (addresses/postal codes), facility information, telephone number information, or the like. The second map information 662 may be updated as needed by the communication device 620 communicating with another device.

The driving operators 680 include, for example, an accelerator pedal, a brake pedal, a shift lever, a steering wheel, a different shaped steering member, a joystick, and other operators. Sensors for detecting the amounts of operation or the presence or absence of operation are attached to the driving operators 680. Results of the detection are output to the automated driving control device 700 or some or all of the travel driving force output device 800, the brake device 810, and the steering device 820.

The automated driving control device 700 includes, for example, a first controller 720 and a second controller 760. Each of the first controller 720 and the second controller 760 is realized, for example, by a hardware processor such as a central processing unit (CPU) executing a program (software). Some or all of these components may be realized by hardware (including circuitry) such as large scale integration (LSI), an application specific integrated circuit (ASIC), a field-programmable gate array (FPGA), or a graphics processing unit (GPU) or may be realized by hardware and software in cooperation. The program may be stored in advance in a storage device such as an HDD or a flash memory (a storage device having a non-transitory storage medium) of the automated driving control device 700 or may be stored in a detachable storage medium such as a DVD or a CD-ROM and then installed in the HDD or flash memory of the automated driving control device 700 by mounting the storage medium (the non-transitory storage medium) in a drive device.

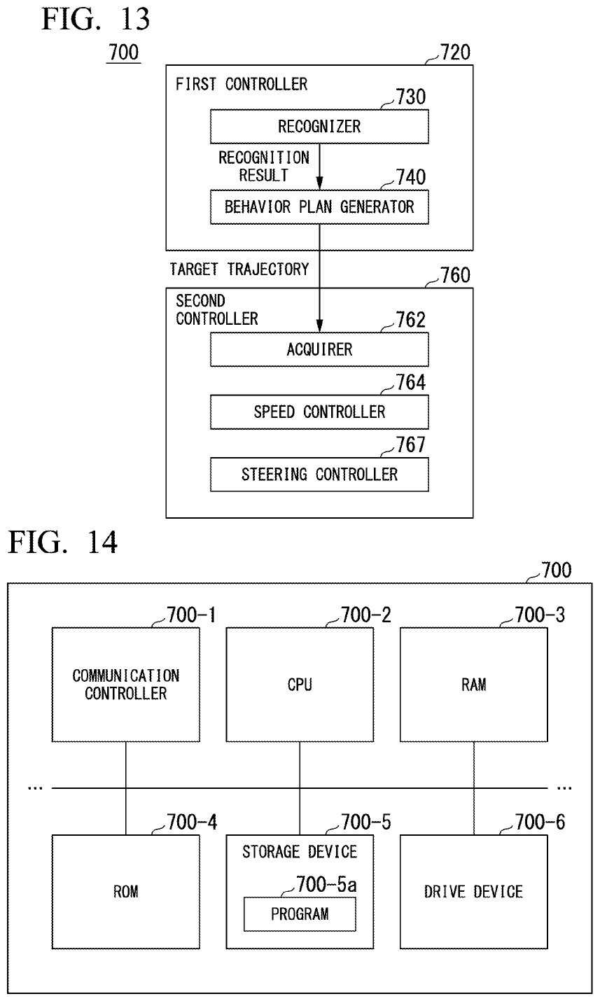

FIG. 13 is a functional configuration diagram of the first controller 720 and the second controller 760. The first controller 720 includes, for example, a recognizer 730 and a behavior plan generator 740. For example, the first controller 720 realizes a function based on artificial intelligence (AI) and a function based on a previously given model in parallel. For example, a function of “recognizing an intersection” is realized by performing recognition of an intersection through deep learning or the like and recognition based on previously given conditions (presence of a signal, a road sign, or the like for which pattern matching is possible) in parallel and evaluating both comprehensively through scoring. This guarantees the reliability of automated driving.

The recognizer 730 recognizes states such as the position, speed and acceleration of each object present near the vehicle M on the basis of information input from the camera 610, the radar device 612, and the finder 614 via the object recognition device 616. The position of the object is recognized, for example, as a position in an absolute coordinate system whose origin is at a representative point on the vehicle M (such as the center of gravity or the center of a drive shaft thereof), and used for control. The position of the object may be represented by a representative point on the object such as the center of gravity or a corner thereof or may be represented by an expressed region. The “states” of the object may include an acceleration or jerk of the object or a “behavior state” thereof (for example, whether or not the object is changing or is going to change lanes).

The recognizer 730 recognizes, for example, a lane in which the vehicle M is traveling (a travel lane). For example, the recognizer 730 recognizes the travel lane, for example, by comparing a pattern of road lane lines (for example, an arrangement of solid and broken lines) obtained from the second map information 662 with a pattern of road lane lines near the vehicle M recognized from an image captured by the camera 610. The recognizer 730 may recognize the travel lane by recognizing travel boundaries (road boundaries) including road lane lines, road shoulders, curbs, a median strip, guardrails, or the like, without being limited to road lane lines. This recognition may be performed taking into consideration a position of the vehicle M acquired from the navigation device 650 or a result of processing by the INS. The recognizer 730 recognizes temporary stop lines, obstacles, red lights, toll gates, and other road phenomena.

When recognizing the travel lane, the recognizer 730 recognizes the position or attitude of the vehicle M with respect to the travel lane. For example, the recognizer 730 may recognize both a deviation from the lane center of the reference point of the vehicle M and an angle formed by the travel direction of the vehicle M relative to an extension line of the lane center as the relative position and attitude of the vehicle M with respect to the travel lane. Alternatively, the recognizer 730 may recognize the position of the reference point of the vehicle M with respect to one of the sides of the travel lane (a road lane line or a road boundary) or the like as the relative position of the vehicle M with respect to the travel lane.

The behavior plan generator 740 generates a target trajectory along which the vehicle M will travel in the future automatically (independently of the driver's operation) such that the vehicle M basically travels in the recommended lane determined by the recommended lane determiner 661 and further copes with situations occurring near the vehicle M. The target trajectory includes, for example, a speed element. The target trajectory is expressed, for example, by an arrangement of points (trajectory points) which are to be reached by the vehicle M in order. The trajectory points are points to be reached by the vehicle M at intervals of a predetermined travel distance (for example, at intervals of about several meters) along the road. Apart from this, a target speed and a target acceleration for each predetermined sampling time (for example, every several tenths of a second) are generated as a part of the target trajectory. The trajectory points may be respective positions at the predetermined sampling times which the vehicle M is to reach at the corresponding sampling times. In this case, information on the target speed or the target acceleration is represented with the interval between the trajectory points.

When generating the target trajectory, the behavior plan generator 740 may set an automated driving event. Examples of the automated driving event include a constant-speed travel event, a lane change event, a branching event, a merging event, and a takeover event. The behavior plan generator 740 generates a target trajectory according to an activated event.

The second controller 760 controls the travel driving force output device 800, the brake device 810, and the steering device 820 such that the vehicle M passes through the target trajectory generated by the behavior plan generator 740 at scheduled times.

The second controller 760 includes, for example, an acquirer 762, a speed controller 764, and a steering controller 766. The acquirer 762 acquires information on the target trajectory (trajectory points) generated by the behavior plan generator 740 and stores it in a memory (not shown). The speed controller 764 controls the travel driving force output device 800 or the brake device 810 on the basis of a speed element pertaining to the target trajectory stored in the memory. The steering controller 766 controls the steering device 820 according to the degree of bending of the target trajectory stored in the memory. The processing of the speed controller 764 and the steering controller 766 is realized, for example, by a combination of feedforward control and feedback control. As an example, the steering controller 766 performs feedforward control according to the curvature of the road ahead of the vehicle M and feedback control based on deviation from the target trajectory in combination. A combination of the behavior plan generator 740 and the second controller 760 is an example of the “driving controller.”

The travel driving force output device 800 outputs a travel driving force (torque) required for the vehicle M to travel to steering wheels. The travel driving force output device 800 includes, for example, a combination of an internal combustion engine, an electric motor, a transmission, and the like and an electronic control unit (ECU) that controls these. The ECU controls these components according to information input from the second controller 760 or information input from the driving operators 680.

The brake device 810 includes, for example, a brake caliper, a cylinder that transmits hydraulic pressure to the brake caliper, an electric motor that generates hydraulic pressure in the cylinder, and a brake ECU. The brake ECU controls the electric motor according to information input from the second controller 760 or information input from the driving operators 680 such that a brake torque corresponding to a braking operation is output to each wheel. The brake device 810 may include, as a backup, a mechanism for transferring a hydraulic pressure generated by an operation of the brake pedal included in the driving operators 680 to the cylinder via a master cylinder. The brake device 810 is not limited to that configured as described above and may be an electronically controlled hydraulic brake device that controls an actuator according to information input from the second controller 760 and transmits the hydraulic pressure of the master cylinder to the cylinder.

The steering device 820 includes, for example, a steering ECU and an electric motor. The electric motor, for example, applies a force to a rack-and-pinion mechanism to change the direction of steering wheels. The steering ECU drives the electric motor according to information input from the second controller 760 or information input from the driving operators 680 to change the direction of the steering wheels.

[End of Automated Driving in Accordance with Control of Control Device 100]

For example, even when the vehicle is traveling to the facility to be visited including the parking lot PA by automated driving, the automated driving control device 700 according to the present embodiment ends the automated driving if a recognition result of the recognizer 730 indicates that a vehicle M is placed on the belt conveyor 500, for example, by causing the behavior plan generator 740 to end the target trajectory generation process or the like. Thereby, the automated driving control device 700 can prevent its automated driving control from hindering processing of the control device 100 while the control device 100 is performing the processing until the vehicle M is parked in the parking space PS by controlling the operation of the belt conveyor 500.

[When Time it Takes to Board or Alight in Stop Area 310 is Equal to or Longer than Predetermined Time]

The control device 100 according to the present embodiment transmits instruction information instructing to start moving at a low speed to the vehicle M in which the vehicle control system SY is mounted through the communication device 120, for example, if a recognition result of the recognizer 114 indicates that the time it takes for a passenger to board or alight from the vehicle M in the stop area 310 is equal to or longer than the predetermined time Tht. Upon receiving the instruction information instructing to start moving at a low speed through the communication device 620, the behavior plan generator 740 generates a target trajectory on the basis of a recognition result of the recognizer 730. The second controller 760 causes the vehicle M to travel at a low speed by controlling the travel driving force output device 800, the brake device 810, and the steering device 820 such that the vehicle M passes through the target trajectory generated by the behavior plan generator 740 at scheduled times. Thereby, the automated driving control device 700 can allow the passenger P to board or alight from the vehicle M and prevent congestion of vehicles following the vehicle M while keeping the vehicle M from passing through the stop area 310.

### [Instruction to Reduce Inter-Vehicle Distance]

The control device 100 according to the present embodiment transmits instruction information instructing to reduce the inter-vehicle distance to the vehicle M, in which the vehicle control system SY is mounted and which is present behind in the travel direction, through the communication device 120 if a recognition result of the recognizer 114 indicates that the inter-vehicle distance dt is equal to or longer than the predetermined threshold Th1. Upon receiving the instruction information instructing to reduce the inter-vehicle distance through the communication device 620, the behavior plan generator 740 generates a target trajectory for reducing the inter-vehicle distance to the preceding vehicle on the basis of a recognition result of the recognizer 730. The second controller 760 reduces the inter-vehicle distance to the preceding vehicle by controlling the travel driving force output device 800, the brake device 810, and the steering device 820 such that the vehicle M passes through the target trajectory generated by the behavior plan generator 740 at scheduled times. Thereby, the automated driving control device 700 allows the vehicle to be efficiently parked.

### Summary of Second Embodiment

The parking lot system 2 of the present embodiment can prevent automated driving control from hindering the processing for transporting the vehicle M as described above. The parking lot system 2 of the present embodiment can efficiently park the vehicle M in the parking space PS by moving the vehicle M in the stop area 310, for example, when the time it takes for the passenger P to board or alight from the vehicle M is equal to or longer than the predetermined time Tht.

### [Installation Range of Belt Conveyor 500]

The above description refers to the case where the belt conveyor 500 is provided in a range from the gates 300 to the parking space PS in the parking lot PA. However, the present invention is not limited to this. The belt conveyor 500 may be configured such that one or more sub-belt conveyors are provided at a part of the range described above. For example, the belt conveyor 500 may be provided only in the stop area 310. Thus, by controlling the belt conveyor 500, the control device 100 can allow passengers to safely board or alight at least in an area where boarding or alighting is performed.

### [Hardware Configuration]

FIG. 14 is a diagram showing an example of a hardware configuration of an automated driving control device 700 of an embodiment. As shown, the automated driving control device 700 is configured such that a communication controller 700-1, a CPU 700-2, a random access memory (RAM) 700-3 used as a working memory, a read only memory (ROM) 700-4 storing a boot program or the like, a storage device 700-5 such as a flash memory or a hard disk drive (HDD), a drive device 700-6, or the like are connected to each other via an internal bus or a dedicated communication line. The communication controller 700-1 performs communication with components other than the automated driving control device 700. The storage device 700-5 stores a program 700-5a to be executed by the CPU 700-2. This program is loaded in the RAM 700-3 by a direct memory access (DMA) controller (not shown) or the like and then executed by the CPU 700-2. Thereby, some or all of the recognizer 730, the behavior plan generator 740, and the self-propelled parking controller 142 are realized.

The embodiments described above can also be expressed as follows.

An automated driving control device including:

a storage device configured to store a program; and

a hardware processor,

wherein the hardware processor is configured to execute the program stored in the storage device to:

control an operation of a transport mechanism configured to transport one or more vehicles placed on the transport mechanism in an area where at least boarding or alighting is performed; and

transport a vehicle placed on the transport mechanism to a parking position.

Although the modes for carrying out the present invention have been described above by way of embodiments, the present invention is not limited to these embodiments at all and various modifications and substitutions can be made without departing from the gist of the present invention.

What is claimed is:

1. A control device comprising:
a transport mechanism configured to transport one or more vehicles placed on the transport mechanism in an area where at least boarding or alighting is performed; and
a transport mechanism controller configured to control an operation of the transport mechanism,
wherein the transport mechanism controller is configured to control the transport mechanism to transport a vehicle placed on the transport mechanism to a parking position.

2. The control device according to claim 1, further comprising a recognizer configured to recognize a surrounding environment of the transport mechanism,
wherein the transport mechanism is provided such that at least a part of the transport mechanism faces a boarding/alighting area where passengers board or alight from vehicles, and
the transport mechanism controller is configured to stop the operation of the transport mechanism when a recognition result of the recognizer indicates that a passenger is boarding or alighting from a vehicle in the boarding/alighting area.

3. The control device according to claim 2, wherein the transport mechanism includes a belt conveyor.

4. The control device according to claim 3, wherein the transport mechanism controller is configured to cause the belt conveyor to operate to transport a vehicle placed on the belt conveyor to a parking area when the recognizer has recognized that no passenger is boarding or alighting from the vehicle placed on the belt conveyor in the boarding/alighting area.

5. The control device according to claim 3, further comprising an instructor configured to, when an inter-vehicle distance between a plurality of vehicles placed on the belt conveyor recognized by the recognizer is equal to or greater than a predetermined threshold, instruct a vehicle, which is relatively behind in a travel direction among the plurality of vehicles, to reduce the inter-vehicle distance.

6. The control device according to claim 3, wherein the transport mechanism controller is configured to cause the belt conveyor to operate at a speed at which a passenger is able to board or alight from a vehicle on the belt conveyor when the recognizer has recognized that a time it takes for the passenger to board or alight from the vehicle in the boarding/alighting area is equal to or longer than a predetermined time.

7. The control device according to claim 3, wherein the belt conveyor includes a plurality of sub-belt conveyors provided in parallel, and
a sub-belt conveyor which a vehicle is to use among the plurality of sub-belt conveyors is predetermined on the basis of the number of passengers in the vehicle.

8. The control device according to claim 3, wherein the belt conveyor includes a plurality of sub-belt conveyors provided in parallel, and
the transport mechanism controller is configured to cause the plurality of sub-belt conveyors to operate at different speeds.

9. The control device according to claim 3, wherein the belt conveyor includes a plurality of sub-belt conveyors provided in parallel, and
a sub-belt conveyor which a vehicle scheduled to use a parking area is to use among the plurality of sub-belt conveyors and a sub-belt conveyor which a vehicle not scheduled to use the parking area is to use are predetermined.

10. A parking lot system comprising the control device according to claim 1 and a vehicle control system, wherein the vehicle control system includes:
a recognizer configured to recognize a surrounding environment of a vehicle; and
a driving controller configured to perform speed control and steering control of the vehicle on the basis of a recognition result of the recognizer, and
the driving controller is configured to stop the speed control and steering control of the vehicle when the recognizer has recognized that the vehicle is placed on a transport mechanism configured to transport one or more vehicles placed on the transport mechanism in an area where at least boarding or alighting is performed.

11. The parking lot system according to claim 10, wherein the driving controller is configured to cause the vehicle to travel to reduce an inter-vehicle distance between the vehicle and another vehicle placed on the transport mechanism when the inter-vehicle distance between the vehicle and the other vehicle recognized by the recognizer is equal to or greater than a predetermined threshold and the vehicle is present behind the other vehicle.

12. The parking lot system according to claim 11, wherein the transport mechanism is provided such that at least a part of the transport mechanism faces a boarding/alighting area where passengers board or alight from vehicles, and
the driving controller is configured to cause the vehicle to advance at a speed at which the passenger is able to board or alight from the vehicle when the recognizer has recognized that a time it takes for the passenger to board or alight from the vehicle in the boarding/alighting area is equal to or longer than a predetermined time.

13. A control method comprising:
a computer controlling an operation of a transport mechanism configured to transport one or more vehicles placed on the transport mechanism in an area where at least boarding or alighting is performed; and
transporting a vehicle placed on the transport mechanism to a parking position.

14. A non-transitory computer-readable storage medium storing a program that causes a computer to:
control an operation of a transport mechanism configured to transport one or more vehicles placed on the transport mechanism in an area where at least boarding or alighting is performed; and
transport a vehicle placed on the transport mechanism to a parking position.
